(19) United States
(12) Patent Application Publication
(10) Pub. No.: US 2014/0028558 A1
(43) Pub. Date: Jan. 30, 2014

(54) INPUT DEVICE

(71) Applicant: Nozomu YASUI, Taipei (TW)

(72) Inventor: Nozomu YASUI, Taipei (TW)

(21) Appl. No.: 13/557,767

(22) Filed: Jul. 25, 2012

(51) Int. Cl. G06F 3/033; G06F 3/048

(52) U.S. Cl. 345/163

(57) ABSTRACT

An example of the input device includes a housing, a processor, a first input member, and a second input member. The input device additionally includes a non-transitory storage medium including instructions that, when executed by the processor, cause the processor to generate a first command in the user interface of the computer program upon movement of the first input member to an actuated position, a second command in the user interface of the computer program upon movement of the second input member to an actuated position, the second command differing from the first command, and a scroll command in the user interface of the computer program upon movement of the housing of the input device in a direction, the scroll command differing from the first command and second command, while the first input member and the second input member are in the actuated positions.

### BACKGROUND

Consumers appreciate ease of use in their electronic devices. They also appreciate cost effective electronic devices. Designers and manufacturers may, therefore, endeavor to create or build electronic devices directed toward one or more of these objectives.

### BRIEF DESCRIPTION OF THE DRAWINGS

The following detailed description references the drawings, wherein:

FIG. 1 is an example of an input device.

FIG. 2 is an example of a flow chart relating to the input device of FIG. 1.

FIG. 3 is an example of a method of scrolling in a user interface of a computer program.

FIG. 4 is an example of an additional element of the method of scrolling of FIG. 3.

### DETAILED DESCRIPTION

An input device, such as a mouse, may include one or more input embers (e.g., buttons that allow an end-user to interact with a user interface of a computer program. The ability to scroll within the user interface via the input device is desirable. Some input devices may utilize a wheel adjacent one or more of the input members that allows such scrolling within the user interface through its rotation. Rotation of this wheel, however, requires an end-user to remove his or her finger from one of the input devices to the wheel which, at least some end-users, may find objectionable because they must look away from the user interface to do so. For such end-users, this is often compounded because they must look away again when removing their finger from the wheel back to the input ember or input members of the input device.

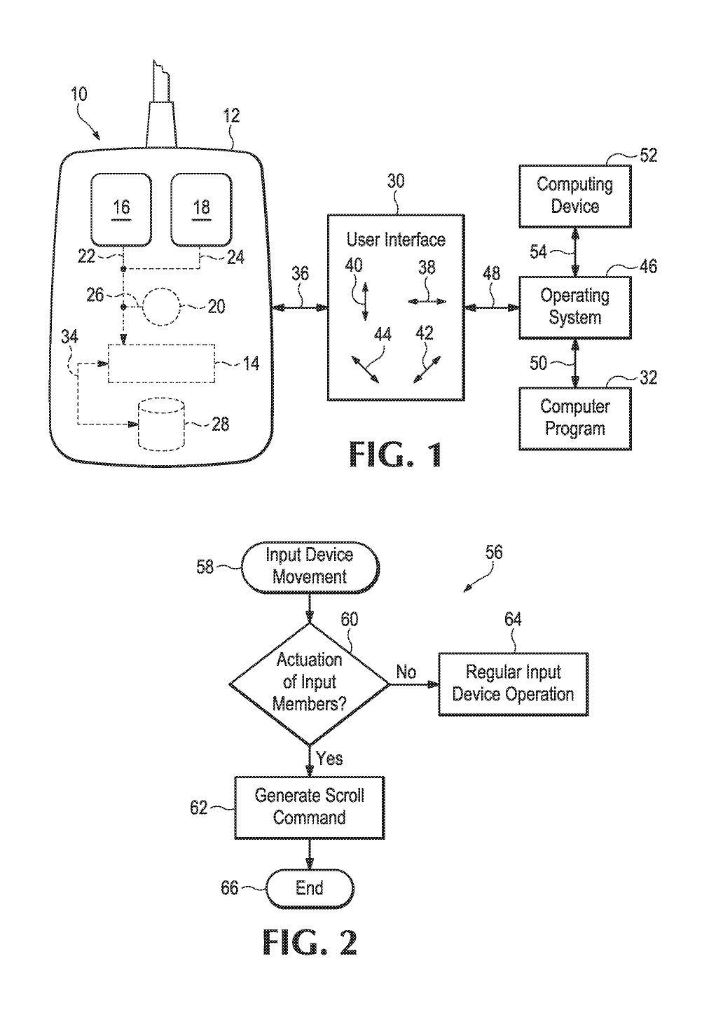

Such scrolling wheels may also add to the cost and complexity of the design and/or manufacture of input devices. Decreasing such cost and/or complexity can be beneficial to consumers. An input device 10 directed to addressing one or more of these objectives is shown in FIG. 1.

As used herein, the terms “non-transitory storage medium” and non-transitory computer-readable storage medium” are defined as including, but not necessarily being limited to, any media that can contain, store, or maintain programs, information, and data. Non-transitory storage medium and non-transitory computer-readable storage medium may include any one of many physical media such as, for example, electronic, magnetic, optical, electromagnetic, or semiconductor media. More specific examples of suitable non-transitory storage medium and non-transitory computer-readable storage medium include, but are not limited to, a magnetic computer diskette such as floppy diskettes or hard drives, magnetic tape, a random access memory (RAM), a read-only memory (ROM), an erasable programmable read-only memory (EPROM), a flash drive, a compact disc (CD), or a digital video disk (DVD).

As used herein, the term “processor” is defined as including, but not necessarily being limited to, an instruction execution system such as a computer/processor based system, an Application Specific Integrated Circuit (ASIC), a computing device, or a hardware and/or software system that can fetch or obtain the logic from a non-transitory storage medium or a non-transitory computer-readable storage medium and execute the instructions contained therein. “Processor” can also include any controller, state-machine, microprocessor, cloud-based utility, service or feature, or any other analogue, digital and/or mechanical implementation thereof.

As used herein, “computer program” is defined as including, but not necessarily being limited to, instructions to perform a task with a processor and may include software applications for tasks such as a word-processing, accounting, finance, and presentations. As used herein, “operating system” is defined as including, but not necessarily being limited to, software that manages computing device or processor hardware resources and provides common services for computer programs such as recognizing commands from input devices, sending output to one or more display screens, managing files and directories on hard drives and controlling peripheral devices. As used herein, “user interface” is defined as including, but not necessarily being limited to, graphical, textual and auditory information a computer program and/or operating system presents to an end-user, as well as the control sequences (such as keystrokes of a keyboard or movements and selections of an input device) the user employs to enter data into and/or control the computer program or operating system.

As used herein, “input device” (e.g., a mouse) is defined as including, but not necessarily being limited to, an apparatus that provides data and/or control signals to a user interface. Input devices may include one or more input members (e.g., buttons, piezo-electric devices, light emitting diodes (LEDs), etc.) that may be actuated by an end-user to provide such data and/or control signals in the form of commands. An input device may also include a tracking member (e.g., a light emitting diode (LED) or ball) that is responsive to movement of the input device by an end-user.

As used herein, “scroll” and “scrolling” are defined as including, but not necessarily being limited to, sliding text, images or video across a monitor or display, vertically (e.g., up or down), horizontally (e.g., left or right), and/or diagonally. “Scrolling” does not change the layout of the text, images or video, but moves an end-user's view across what is apparently a larger image that may not be wholly seen.

Referring again to FIG. 1, input device 10 includes a housing 12 defining an interior in which processor 14 is disposed. Input device 10 includes a first input member 16 that has an actuated (e.g., depressed) position and a second input member 18 that also has an actuated (e.g., depressed) position. Input device 10 also includes a tracking member 20, in this example, located on the bottom of housing 12 that is responsive to movement of housing. As can be seen in FIG. 1, processor 14 is coupled first input member 16 to receive one or more signals therefrom representative of actuation of first input member 16, as indicated by dashed arrow 22. Processor 14 is also coupled to second input member 18 to receive signals therefrom representative of actuation of second input member 18, as indicated by dashed arrow 24. As can additionally be seen in FIG. 1, processor 14 is further coupled to tracking member 20 to receive signals therefrom representative of movement of housing 12, as indicated by dashed arrow 26.

As can also be seen in FIG. 1, input device 10 additionally includes a non-transitory storage medium 28 disposed in interior of housing 12. Non-transitory storage medium 28 includes instructions, that when executed by processor 14, cause processor 14 to generate a first command in user interface 30 of a computer program 32 upon movement of first input member 16 to an actuated position. Non-transitory storage medium 28 includes additional instructions that, when executed by processor 14, cause processor 14 to generate a second command in user interface 30 of computer program 32 upon movement of second input member 18 to an actuated position, This second command is different than the first command. Non-transitory storage medium 28 includes further instructions that, when executed by processor 14, cause processor 14 to generate a scroll command in user interface 30 of computer program 32 upon movement of first input member 16 to the actuated position, second input member 18 to the actuated position at a substantially same time, and movement of housing 12 in a direction, as detected by tracking member 20. This scroll command is different from either the first command or the second command.

As can additionally be seen in FIG. 1, processor 14 is coupled to non-transitory storage medium 28 to receive instructions therefrom and to write data thereto for subsequent use, as indicated by double-headed dashed arrow 34. Although processor 14 and non-transitory storage medium 28 are disposed in the interior of housing 12 in the example shown in FIG. 1, it is to be understood that in other examples of input device 10, either or both of them may be located outside of the interior of housing 12 and in computing device 52 instead, for example.

Input device 10 is coupled to user interface 30, as indicated by double-headed arrow 36, by wire (e.g., USB connection) or wirelessly (e.g., Bluetooth) so that movements of housing 12, which are detected by tracking device 20 and converted into signals, are transmitted to user interface 30. When first and second input members 16 and 18 are both actuated (e.g., pressed-down) during these movements of housing 12, they result in scroll commands within user interface 30 of computer program 32. These scroll commands may be horizontal (e.g., left and right), as indicated by double-headed arrow 38, based upon corresponding horizontal movement of housing vertical (e.g., up and down), as indicated by double-headed arrow 40, based upon corresponding vertical movement of housing and/or diagonal, as indicated by double-headed arrows 42 and 44, based upon corresponding diagonal movement of housing 12.

As can still further be seen in FIG. 1, user interface 30 interacts with computer program 32 via operating system 46, as indicated by double-headed arrows 48 and 50. Operating system 46, in turn, interacts with computing device 52, as indicated by double-headed arrow 54. In this example of input device 10, user interface 30, computer program 32, and operating system 46 all reside on or in computing device 52. In other examples of input device 10, one or more of user interface 30, computer program 32, and operating system 46 may reside elsewhere. Additionally, at least of portion of user interface 30 visible by end-users is displayed on a screen or monitor (not shown) associated with computing device 52.

Non-transitory storage medium 28 may include additional instructions that, when executed by processor 14, cause processor 14 to reconfigure one or more of the scroll commands based on end-user input so that one or more different scroll commands are generated in user-interface 30 of computer program 32 based upon movement of housing 12. That is, an end-user may reconfigure input device 10 so that, when first and second input members 16 and 18 are actuated (e.g., pressing of buttons), and housing 12 is moved in a particular direction (e.g., right), the direction of scroll in user interface 30 does not directly correspond (e.g., left instead). This reconfiguration can be changed back at any time, should the end-user so desire. As noted above, it can also be selectively applied to one or more of the scroll directions.

An example of a flow chart 56 relating to input device 10 is shown in FIG. 2. As can be seen in FIG. 2, flow chart 56 begins with input device 10 movement, as indicated by element or component 58. Next, it is determined whether both of respective first and second input members 16 and 18 are actuated during this movement, as indicated by element or component 60. If yes, then a scroll command is generated, as indicated by element or component 62. If no, then regular or normal input device 10 operation (e.g., movement of an icon or cursor within user interface 30) occurs, as indicated by element or component 64. Flow chart 56 may then end 66.

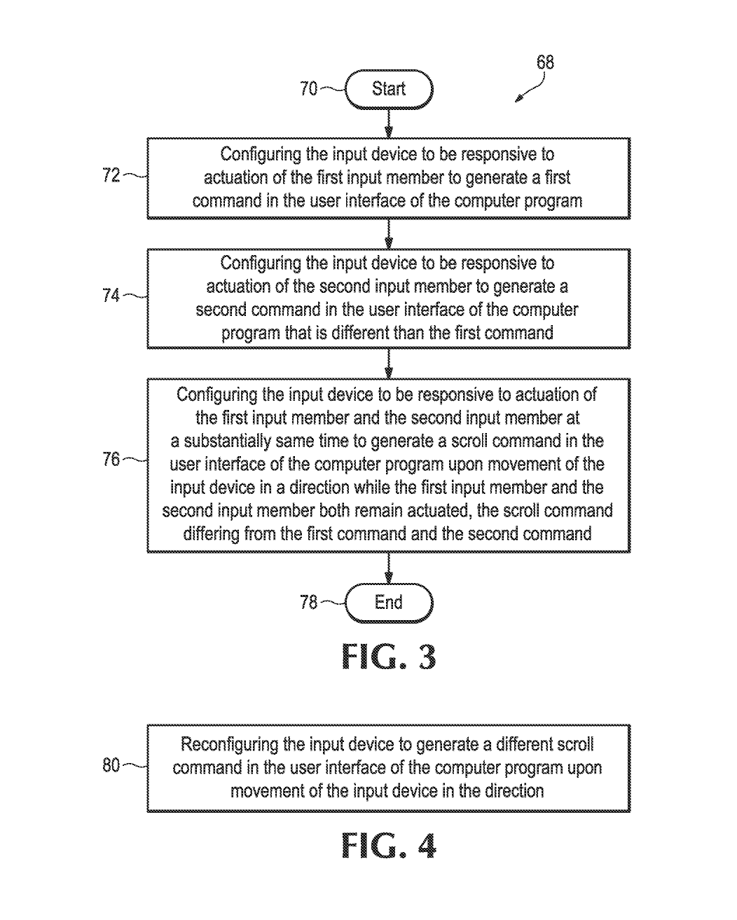

An example of a method of scrolling 68 in user interface 30 of computer program 32 via input device 10 having first input ember 16 and second input member 18 is shown in FIG. 3. As can be seen in FIG. 3, method 68 starts 70 by configuring the input device 10 to be responsive to actuation of the first input member 16 to generate a first command in the user interface of the computer program, as indicated by element or module 72, and configuring the input device 10 to be responsive to actuation of the second input member 18 to generate a second command in the user interface of the computer program that is different from the first command, as indicated by element or module 74. Method 68 continues by configuring input device 10 to be responsive to actuation of the first input member and the second input member at a substantially same time to generate a scroll command in user interface 30 of computer program 32 upon movement of input device 10 in a direction while first input member 16 and second input member 18 both remain actuated, as indicated by element or module 76. This scroll command is different from either the first command or the second command. Method 68 may then end 78.

An example of an additional element of method 68 is shown in FIG. 4. As can be seen in FIG. 4, method 68 may additionally include reconfiguring input device 10 to generate a different scroll command in user interface 30 of computer program 32 upon movement of input device 10 in the direction, as indicated by element or module 80. Also or alternatively, the scroll command of method 68 may cause movement in user interface 30 in an up direction, a down direction, a left direction, or a right direction. Additionally or alternatively, the direction of movement of input device 10 may be in an up direction, a down direction, a left direction, or a right direction.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. The spirit and scope of the present invention are to be limited only by the terms of the following claims.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. A method of scrolling in a user interface of a computer program via an input device having a first input member and a second input member, the method comprising:
configuring the input device to be responsive to actuation of the first input member to generate a first command in the user interface of the computer program;
configuring the input device to be responsive to actuation of the second input member to generate a second command in the user interface of the computer program that is different than the first command; and
configuring the input device to be responsive to actuation of the first input member and the second input member at a substantially same time to generate a scroll command in the user interface of the computer program upon movement of the input device in a direction while the first input member and the second input member both remain actuated, the scroll command differing from the first command and the second command.

2. The method of claim 1, wherein the scroll command causes movement in the user interface in one of an up direction, a down direction, a left direction, and a right direction.

3. The method of claim 1, wherein the direction of movement of the input device includes one of an up direction, a down direction, a left direction, and a right direction.

4. The method of claim 1, wherein the input device includes a mouse.

5. The method of claim 1, wherein one of the first input member and the second input member includes a button.

6. The method of claim 1, further comprising reconfiguring the input device to generate a different scroll command in the user interface of the computer program upon movement of the input device in the direction.

7. An input device for use with a user interface of a computer program, the input device comprising:
a housing;
a processor;
a first input member including an actuated position;
a second input member including an actuated position;
a tracking member responsive to movement of the housing; and
a non-transitory storage medium including instructions that, when executed by the processor, cause the processor to:
generate a first command in the user interface of the computer program upon movement of the first input member to the actuated position;
generate a second command in the user interface of the computer program upon movement of the second input member to the actuated position, the second command differing from the first command; and
generate a scroll command in the user interface of the computer program upon movement of the first input member to the actuated position, movement of the second input member to the actuated position at a substantially same time, and movement of the housing of the input device in a direction, as detected by the tracking member, the scroll command differing from the first command and the second command.

8. The input device of claim 7, wherein one of the processor and the non-transitory storage medium is in the housing.

9. The input device of claim 7, wherein one of the first input member and the second input member includes a button.

10. The input device of claim 7, wherein the tracking member includes a light-emitting diode.

11. The input device of claim 7, further comprising a computing device.

12. The input device of claim 7, further comprising additional instructions that, when executed by the processor, cause the processor to reconfigure the scroll command based on end-user input so that a different scroll command is generated in the user-interface of the computer program upon movement of the housing in the direction.

13. A non-transitory storage medium including instructions that, when executed by a processor, cause the processor to:
respond to actuation of a first input member of an input device by generating a first command;
respond to actuation of a second input member of the input device by generating a second command that is different than the first command; and
generate a scroll command in a user interface of a computer program upon movement of the input device in a direction while the first input member and the second input member are both actuated at a substantially same time, the scroll command differing from the first command and the second command.

14. The non-transitory storage medium of claim 13, in one of a mouse and a computing device.

15. The non-transitory storage medium of claim 13, further comprising moving in the user interface of the computer program in one of an up direction, a down direction, a left direction, and a right direction.

16. The non-transitory storage medium of claim 13, wherein the direction of movement of the input device includes one of an up direction, a down direction, a left direction, and a right direction.

17. The non-transitory storage medium of claim 13, in one of a mouse and a computing device.

18. The non-transitory storage medium of claim 13, wherein a direction of movement generated by the scroll command is configured by an end-user.
